(19) United States
(12) Patent Application Publication
(10) Pub. No.: US 2026/0074612 A1
(43) Pub. Date: Mar. 12, 2026

(54) POWER FACTOR CORRECTION CONVERTER SUPPRESSING INRUSH CURRENT USING SPIRITO EFFECT

(71) Applicant: POTENS SEMICONDUCTOR CORP., Hsinchu County (TW)

(72) Inventors: Wen Nan Huang, Hsinchu County (TW); Ching Kuo Chen, Hsinchu County (TW); Chih Ming Yu, Hsinchu County (TW); I Ming Lo, Hsinchu County (TW)

(73) Assignee: POTENS SEMICONDUCTOR CORP., Hsinchu County (TW)

(21) Appl. No.: 19/194,416

(22) Filed: Apr. 30, 2025

(30) Foreign Application Priority Data
Sep. 10, 2024 (TW) 113134316

(51) Int. Cl. H02M 1/42; H02M 7/217

(52) U.S. Cl. CPC H02M 1/4208; H02M 7/217

(57) ABSTRACT

A power factor correction (PFC) converter that suppresses inrush current using a Spirito effect is provided. The PFC converter is composed of an inductor, a plurality of transistors, and a capacitor. By serially connecting a fifth transistor with the capacitor and controlling, via a control unit, gate-to-source voltage of the fifth transistor so that the fifth transistor operates in a high-impedance state, the inrush current generated when an alternating current (AC) power source is connected is suppressed. Thus, power component damage caused by the inrush current is prevented, and power consumption is reduced, enabling the PFC converter to maintain optimal performance under high-power operation.

### CROSS-REFERENCE TO RELATED APPLICATION

The present disclosure claims priority to a Taiwan Patent Application No. 113134316 filed on Sep. 10, 2024, the disclosure of which is incorporated in its entirety by reference herein.

### BACKGROUND OF THE DISCLOSURE

### Field of the Disclosure

The present disclosure relates to a power factor correction (PFC) converter, and more particularly to a PFC converter with an inrush current suppression function.

### Brief Description of Related Art

At the moment when a power factor correction (PFC) converter is connected to an alternating current (AC) power source, current rapidly charges a capacitor, generating inrush current significantly higher than steady-state current. If this inrush current exceeds a reverse current tolerance of a switching element such as a metal-oxide-semiconductor field-effect transistor (MOSFET), a GaN field-effect transistor (FET), or a SiC MOSFET, there is a risk of damaging the aforementioned component.

Most existing applications use a negative temperature coefficient (NTC) thermistor connected in series within a PFC circuit. The thermistor exhibits high resistance at low temperatures and low resistance at high temperatures, which helps limit potential electronic component damage caused by the inrush current. Additionally, by using a half-bridge dual boost PFC converter or a bridgeless PFC converter to replace a traditional full-bridge PFC converter, rectifier diode loss can be further reduced. However, if the power source is turned on in a high-temperature environment or is repeatedly turned on and off, sensitivity of the NTC thermistor significantly decreases due to limited temperature variation, rendering the NTC thermistor ineffective in suppressing the inrush current. Thus, improving the PFC converter to achieve effective inrush current suppression is a problem that needs to be solved.

### SUMMARY OF THE DISCLOSURE

In view of the aforementioned problems, a main object of the present disclosure is to provide a power factor correction (PFC) converter that can effectively reduce rectification loss, and address the problem of excessive inrush current causing power component damage.

To achieve the aforementioned object, a PFC converter that suppresses inrush current using a Spirito effect is provided in the present disclosure. The PFC converter mainly utilizes a characteristic of a power component: impedance of the power component is higher under high-voltage condition due to the Spirito effect. By connecting the power component in series with the PFC converter, the inrush current can be effectively reduced. Furthermore, by implementing the PFC converter as a bridgeless PFC converter or a dual boost PFC converter, the number of diodes is reduced, thereby addressing the problem of power component loss under high-power condition.

### BRIEF DESCRIPTION OF THE DRAWINGS

FIG. 1 is a block diagram according to the present disclosure.

FIG. 2 is a flowchart of an implementation according to the present disclosure.

FIG. 3 is a schematic diagram illustrating voltage and current states according to the present disclosure.

FIG. 4 is a block diagram illustrating another embodiment according to the present disclosure.

### DETAILED DESCRIPTION OF PREFERRED EMBODIMENTS

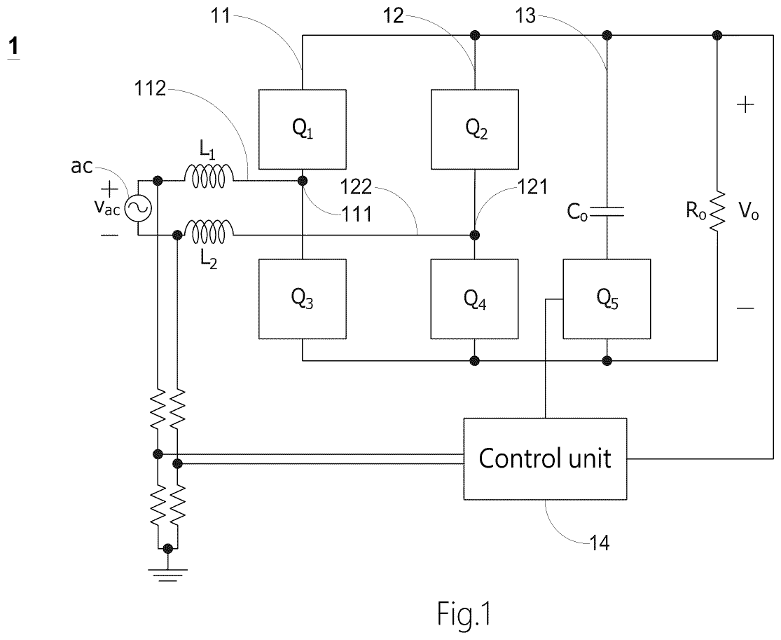

Referring to FIG. 1, a bridgeless power factor correction (PFC) converter 1 that suppresses inrush current using a Spirito effect is provided in the present disclosure. The bridgeless PFC converter 1 has an input terminal connected to an alternating current (AC) power source ac and an output terminal connected to a load Rₒ. The bridgeless PFC converter 1 is configured to convert the AC power source ac through full-wave rectification. The bridgeless PFC converter 1 includes the following:
(1) a first bridge arm 11 having a first transistor Q₁ and a third transistor Q₃ connected in series, wherein a first midpoint 111 between the first transistor Q₁ and the third transistor Q₃ has a first terminal 112 connected to the AC power source ac through a first inductor L₁;
(2) a second bridge arm 12 connected in parallel with the first bridge arm 11 and having a second transistor Q₂ and a fourth transistor Q₄ connected in series, wherein a second midpoint 121 between the second transistor Q₂ and the fourth transistor Q₄ has a second terminal 122 connected to the AC power source ac through a second inductor L₂;
(3) a third bridge arm 13 connected in parallel with the second bridge arm 12 and having a capacitor C₀ and a fifth transistor Q₅ connected in series; and
(4) a control unit 14 connected to the load R₀, a gate of the fifth transistor Q₅, and the AC power source ac, wherein the control unit 14 controls gate-to-source voltage of the fifth transistor Q₅ according to input AC voltage v_{ac} of the AC power source ac and capacitor voltage of the capacitor C₀.
(5) Each of the first transistor Q₁, the second transistor Q₂, the third transistor Q₃, and the fourth transistor Q₄ can be a metal-oxide-semiconductor field-effect transistor (MOSFET), GaN field-effect transistor (FET), SiC MOSFET, or insulated gate bipolar transistor (IGBT). The fifth transistor Q₅, in particular, can be a power component with a short reverse recovery time, such as a GaN FET or SiC MOSFET, to further reduce power consumption.

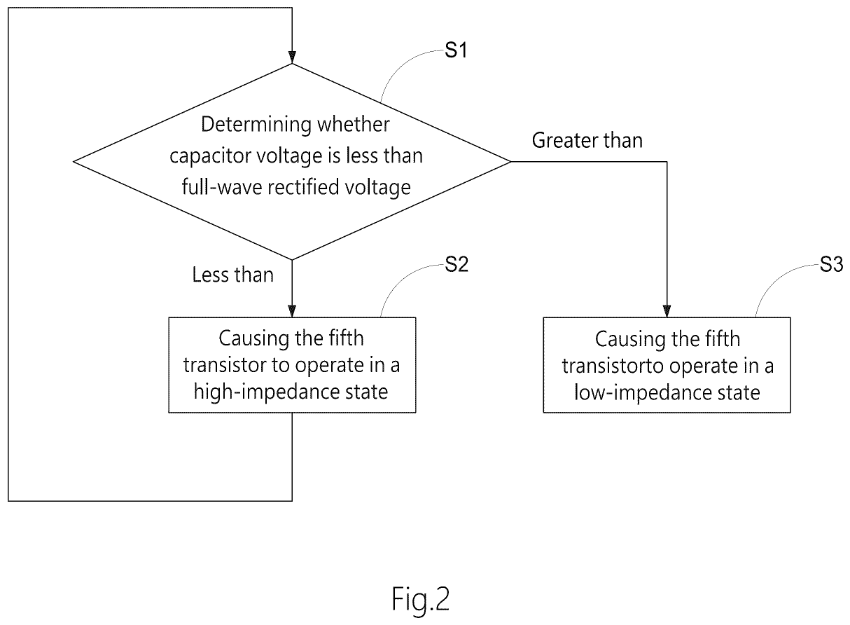

The Spirito effect is observed in a high-voltage region of a safe operating area (SOA) of a power component such as a MOSFET. In this region, the lower the drain current corresponding to drain-to-source voltage, the higher the on-state resistance formed by the two. This region is referred to as a Spirito region. Referring to FIG. 2, the control unit 14 detects the capacitor voltage of the capacitor C₀ and the input AC voltage v_{ac}, and determines whether the capacitor voltage is less than full-wave rectified voltage S1. When the capacitor voltage is less than the full-wave rectified voltage obtained by rectifying the AC power source ac, it indicates that the AC power source ac is a transient-state input, and resulting current is the inrush current. The control unit 14 controls the gate-to-source voltage of the fifth transistor Q₅ so that on-state resistance of the fifth transistor Q₅ falls within the Spirito region, causing the fifth transistor Q₅ to operate in a high-impedance state S2. Thus, suppression of the inrush current is achieved. When the capacitor voltage is greater than the full-wave rectified voltage obtained by rectifying the AC power source ac, it indicates that the AC power source ac is a steady-state input, and the bridgeless PFC converter 1 enters a PFC boost operating region. The control unit 14 adjusts the gate-to-source voltage of the fifth transistor Q₅ to a normal gate drive voltage level, causing the fifth transistor Q₅ to operate in a low-impedance state S3. This allows the circuit to resume performing a PFC boost function with power loss of the circuit effectively reduced.

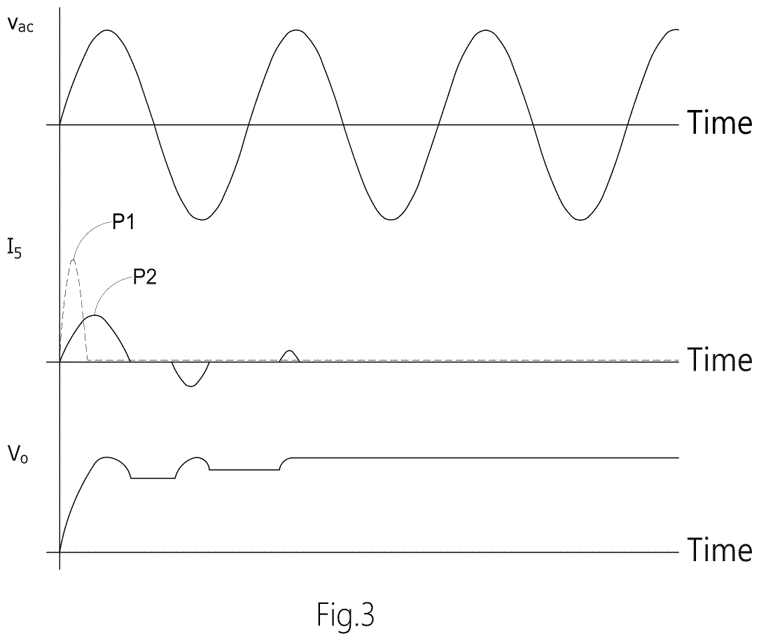

Refer to FIG. 3, where drain current I₅ of the fifth transistor Q₅ is illustrated. A dashed line represents a component or device without inrush current suppression, exhibiting a dashed peak P1. A solid line represents the bridgeless PFC converter 1 of the present disclosure, exhibiting a solid peak P2. At the moment when the AC power source ac is connected, a current peak value of the solid peak P2 is significantly reduced compared to that of the dashed peak P1, indicating effectiveness of inrush current suppression. The capacitor C₀ is charged and discharged by the drain current I₅, and output voltage V₀ gradually increases according to magnitude of the drain current I₅, as illustrated in the figure.

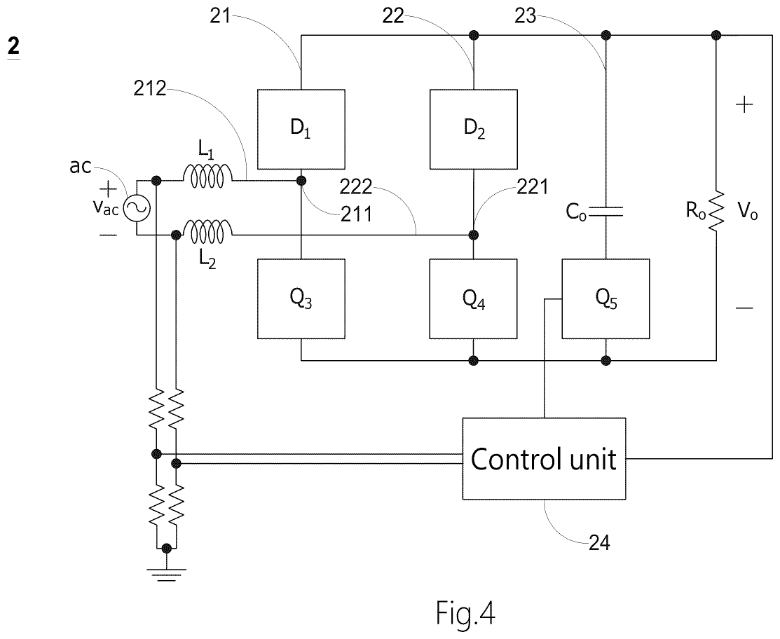

Referring to FIG. 4, a dual boost PFC converter 2 that suppresses inrush current using the Spirito effect is provided in another embodiment of the present disclosure. The dual boost PFC converter 2 has an input terminal connected to an AC power source ac and an output terminal connected to a load Rₒ. The dual boost PFC converter 2 is configured to convert the AC power source ac through full-wave rectification. The dual boost PFC converter 2 includes the following:
(1) a first bridge arm 21 having a first diode D₁ and a third transistor Q₃ connected in series, wherein a first midpoint 211 between the first diode D₁ and the third transistor Q₃ has a first terminal 212 connected to the AC power source ac through a first inductor L₁;
(2) a second bridge arm 22 connected in parallel with the first bridge arm 21 and having a second diode D₂ and a fourth transistor Q₄ connected in series, wherein a second midpoint 221 between the second diode D₂ and the fourth transistor Q₄ has a second terminal 222 connected to the AC power source ac through a second inductor L₂;
(3) a third bridge arm 23 connected in parallel with the second bridge arm 22 and having a capacitor C₀ and a fifth transistor Q₅ connected in series; and
(4) a control unit 24 connected to the load R₀, a gate of the fifth transistor Q₅, and the AC power source ac, wherein the control unit 14 controls gate-to-source voltage of the fifth transistor Q₅ according to input AC voltage v_{ac} of the AC power source ac and capacitor voltage of the capacitor C₀.
(5) Each of the third transistor Q₃ and the fourth transistor Q₄ can be a MOSFET, GaN FET, SiC MOSFET, or IGBT. The fifth transistor Q₅, in particular, can be a power component with a short reverse recovery time, such as a GaN FET or SiC MOSFET, to further reduce power consumption.
(6) Refer to implementation details described with reference to FIG. 2 and FIG. 3 for implementation details of the present embodiment.

As mentioned above, in the present disclosure, by serially connecting a transistor in a bridgeless or dual boost PFC converter and controlling variation of on-state resistance of the transistor using a Spirito effect under high-voltage condition, inrush current is effectively suppressed, power consumption is reduced, and thus, optimal operational performance is maintained. As mentioned above, the present disclosure, upon implementation, can indeed achieve an object of providing a PFC converter that can effectively reduce rectification loss, and address a problem of excessive inrush current causing power component damage.

The above is only the preferred embodiments of the present disclosure, and is not intended to limit the present disclosure to the forms disclosed. Any modifications, equivalent alternatives, and improvements made within the spirit and the scope of present disclosure by persons skilled in the art should be included in the scope of claims of the present disclosure.

### REFERENCE NUMERALS IN DRAWINGS

1 a bridgeless PFC converter
11 a first bridge arm
12 a second bridge arm
111 a first midpoint
121 a second midpoint
112 a first terminal
122 a second terminal
13 a third bridge arm
14 a control unit
Q₁ a first transistor
Q₂ a second transistor
Q₃ a third transistor
Q₄ a fourth transistor
Q₅ a fifth transistor
L₁ a first inductor
L₂ a second inductor
ac an AC power source
v_{ac} input AC voltage
Cₒ a capacitor
Rₒ a load
Vₒ output voltage
I₅ drain current
P1 a dashed peak
P2 a solid peak
2 a dual boost PFC converter
21 a first bridge arm
22 a second bridge arm
211 a first midpoint
221 a second midpoint
212 a first terminal
222 a second terminal
23 a third bridge arm
24 a control unit
D₁ a first diode
D₂ a second diode
S1 Determining whether the capacitor voltage is less than full-wave rectified voltage
S2 Causing the fifth transistor to operate in a high-impedance state
S3 Causing the fifth transistor to operate in a low-impedance state

What is claimed is:

1. A bridgeless power factor correction (PFC) converter that suppresses inrush current using a Spirito effect, wherein the bridgeless PFC converter has an input connected to an alternating current (AC) power source and an output connected to a load, and comprises:
a first bridge arm having a first transistor and a third transistor connected in series, wherein a first midpoint between the first transistor and the third transistor has a first terminal connected to the AC power source through a first inductor;
a second bridge arm connected in parallel with the first bridge arm and having a second transistor and a fourth transistor connected in series, wherein a second midpoint between the second transistor and the fourth transistor has a second terminal connected to the AC power source through a second inductor;
a third bridge arm connected in parallel with the second bridge arm and having a capacitor and a fifth transistor connected in series; and
a control unit connected to the load, a gate of the fifth transistor, and the AC power source, wherein the control unit controls gate-to-source voltage of the fifth transistor according to input AC voltage of the AC power source and capacitor voltage of the capacitor.

2. The bridgeless PFC converter of claim 1, wherein the control unit, upon detecting that the input AC voltage is at a moment when the input AC voltage is input, and the capacitor voltage is less than full-wave rectified voltage of the input AC voltage, controls the gate-to-source voltage so that the fifth transistor operates in a high-impedance state.

3. The bridgeless PFC converter of claim 1, wherein the control unit, upon detecting that the input AC voltage is a steady-state input, and the capacitor voltage is greater than full-wave rectified voltage of the input AC voltage, controls the gate-to-source voltage so that the fifth transistor operates in a low-impedance state.

4. The bridgeless PFC converter of claim 1, wherein the fifth transistor is one of a GaN field-effect transistor (FET), or a SiC metal-oxide-semiconductor field-effect transistor (MOSFET).

5. A dual boost power factor correction (PFC) converter that suppresses inrush current using a Spirito effect, wherein the dual boost PFC converter has an input connected to an alternating current (AC) power source and an output connected to a load, and comprises:
a first bridge arm having a first diode and a third transistor connected in series, wherein a first midpoint between the first diode and the third transistor has a first terminal connected to the AC power source through a first inductor;
a second bridge arm connected in parallel with the first bridge arm and having a second diode and a fourth transistor connected in series, wherein a second midpoint between the second diode and the fourth transistor has a second terminal connected to the AC power source through a second inductor;
a third bridge arm connected in parallel with the second bridge arm and having a capacitor and a fifth transistor connected in series; and
a control unit connected to the load, a gate of the fifth transistor, and the AC power source, wherein the control unit controls gate-to-source voltage of the fifth transistor according to input AC voltage of the AC power source and capacitor voltage of the capacitor.

6. The dual boost PFC converter of claim 5, wherein the control unit, upon detecting that the input AC voltage is at the moment when the input AC voltage is input, and the capacitor voltage is less than full-wave rectified voltage of the input AC voltage, controls the gate-to-source voltage so that the fifth transistor operates in a high-impedance state.

7. The dual boost PFC converter of claim 5, wherein the control unit, upon detecting that the input AC voltage is a steady-state input, and the capacitor voltage is greater than full-wave rectified voltage of the input AC voltage, controls the gate-to-source voltage so that the fifth transistor operates in a low-impedance state.

8. The dual boost PFC converter of claim 5, wherein the fifth transistor is one of a GaN field-effect transistor (FET), or a SiC metal-oxide-semiconductor field-effect transistor (MOSFET).
